(19) United States
(12) Patent Application Publication
(10) Pub. No.: US 2024/0210650 A1
(43) Pub. Date: Jun. 27, 2024

(54) LENS MODULE

(71) Applicant: SAMSUNG ELECTRO-MECHANICS CO., LTD., Suwon-si (KR)

(72) Inventors: Yeo Ok JEON, Suwon-si (KR); Se Yeon HWANG, Suwon-si (KR); Seok Hwan KIM, Suwon-si (KR)

(73) Assignee: SAMSUNG ELECTRO-MECHANICS CO., LTD., Suwon-si (KR)

(21) Appl. No.: 18/494,249

(22) Filed: Oct. 25, 2023

(30) Foreign Application Priority Data
Dec. 21, 2022 (KR) 10-2022-0180898

(51) Int. Cl. G02B 7/02

(52) U.S. Cl. CPC G02B 7/021; G02B 7/04

(57) ABSTRACT

A lens module is provided. The lens module includes a plurality of lenses disposed along an optical axis, a lens barrel configured to accommodate the plurality of lenses, and a fixing member configured to fix at least one of the plurality of lenses to the lens barrel. The lens barrel includes a through-hole which accommodates a portion of the fixing member, a first end of the fixing member protrudes outwardly of the through-hole, and a diameter of the first end of the fixing member is greater than a diameter of the through-hole.

### CROSS-REFERENCE TO RELATED APPLICATIONS

This application claims the benefit under 35 USC § 119(a) of Korean Patent Application No. 10-2022-0180898 filed on Dec. 21, 2022, in the Korean Intellectual Property Office, the entire disclosure of which is incorporated herein by reference for all purposes.

### BACKGROUND

### 1. Field

The following description relates to a lens module.

### 2. Description of the Background

Typically, a camera module may be installed in a portable communication terminal such as, but not limited to, a mobile phone, a personal digital assistant (PDA), a portable personal computer (PC), and the like.

Such a camera module may be provided with a plurality of lenses in a stack, and light passing through the plurality of lenses may be collected by an image sensor and stored as data on a memory in the device.

A lens barrel may be provided to accommodate a plurality of lenses. A plurality of lenses may be fixed to the lens barrel, and a focal length may be adjusted by maintaining a distance between the fixed lenses.

Typically, after inserting a lens into the lens barrel, the lens may be fixed to the lens barrel by a process of applying a bond, curing, and fixing the lens. However, when assembling the lens by applying the bond, deformation of the bond may occur due to dropping, vibrations or the like, and this may cause the lens to move. Therefore, there may be a problem in that the distance between the lenses may be distorted and the focal length of the camera module may be changed, causing resolution defects.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect a lens module includes a lens barrel; a plurality of lenses disposed in the lens barrel along an optical axis; and a fixing member configured to fix at least one of the plurality of lenses to the lens barrel, wherein the lens barrel comprises a through-hole which accommodates a portion of the fixing member, wherein a first end of the fixing member protrudes outwardly of the through-hole, and wherein a diameter of the first end of the fixing member is greater than a diameter of the through-hole.

The fixing member may include a fixing portion which contacts at least one of the plurality of lenses, and an accommodating portion which is accommodated in the through-hole of the lens barrel.

The diameter of the first end of the fixing member may be greater than a diameter of the accommodating portion.

The fixing portion may be connected to the accommodating portion, and wherein the fixing portion may be in contact with a lens which is disposed on an outermost side of the lens barrel in a positive direction of the optical axis from among the plurality of lenses.

The lens barrel may include a support portion which supports a lens disposed on an outermost side of the lens barrel in a negative direction of the optical axis from among the plurality of lenses.

The lens barrel may include a groove portion in which the fixing portion is disposed.

The accommodating portion may have a length in an optical axis direction, and the fixing portion may have a length in a direction, perpendicular to the optical axis direction.

The fixing member may be formed of a plastic material.

The lens module may further include a spacer disposed between two lenses disposed adjacently among the plurality of lenses.

The fixing member may be provided in a plural number.

The fixing member may be disposed symmetrically with respect to the optical axis.

In a general aspect, a lens module includes a lens barrel; a plurality of lenses disposed in the lens barrel along an optical axis; and a fixing member configured to fix at least one of the plurality of lenses to the lens barrel, wherein a first side of the fixing member contacts the lens barrel, wherein a second side of the fixing member is in contact with one of the plurality of lenses, and wherein the fixing member is fixed to the lens barrel.

The lens module may further include a spacer disposed between two lenses disposed adjacently among the plurality of lenses.

The fixing member may be formed of a plastic material.

The first side of the fixing member may be plate-shaped.

The lens barrel may include a through-hole in which a portion of the fixing member is accommodated.

In a general aspect, a lens module includes a lens barrel; a plurality of lenses disposed in the lens barrel on an optical axis; a fixing pin configured to fix a first lens of the plurality of lenses to the lens barrel, wherein the fixing pin is disposed in the through-hole, wherein a first end of the fixing pin contacts the lens barrel and the first lens, and wherein a second end of the fixing pin is welded to the lens barrel to cover the through-hole.

A diameter of the first end of the fixing member may be greater than a diameter of the through-hole.

A diameter of the second end of the fixing pin may be greater than a diameter of a lower end of the through-hole.

Other features and examples will be apparent from the following detailed description, the drawings, and the claims.

### BRIEF DESCRIPTION OF DRAWINGS

FIG. 1 illustrates a perspective view of an example lens module, in accordance with one or more embodiments.

FIG. 2 illustrates an exploded perspective view of an example lens module, in accordance with one or more embodiments.

FIG. 3 illustrates a perspective view of an example lens barrel, in accordance with one or more embodiments.

FIG. 4 illustrates a perspective view of an example fixing member and an example lens barrel before ultrasonic welding is performed, in accordance with one or more embodiments.

FIG. 5 illustrates a perspective view of an example fixing member and an example lens barrel after ultrasonic welding is performed, in accordance with one or more embodiments.

FIG. 6 illustrates a cross-sectional view taken along line I-I′ of FIG. 1.

FIG. 7 illustrates a plan view of an example spacer, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment”, and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

One or more examples may provide a lens module in which a lens may be fixed to a lens barrel.

One or more examples may provide a lens module in which a plurality of lenses are accommodated and a constant distance between the lenses may be maintained.

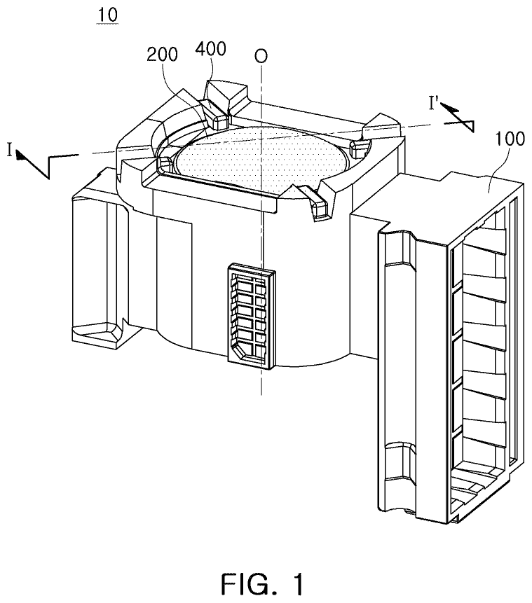

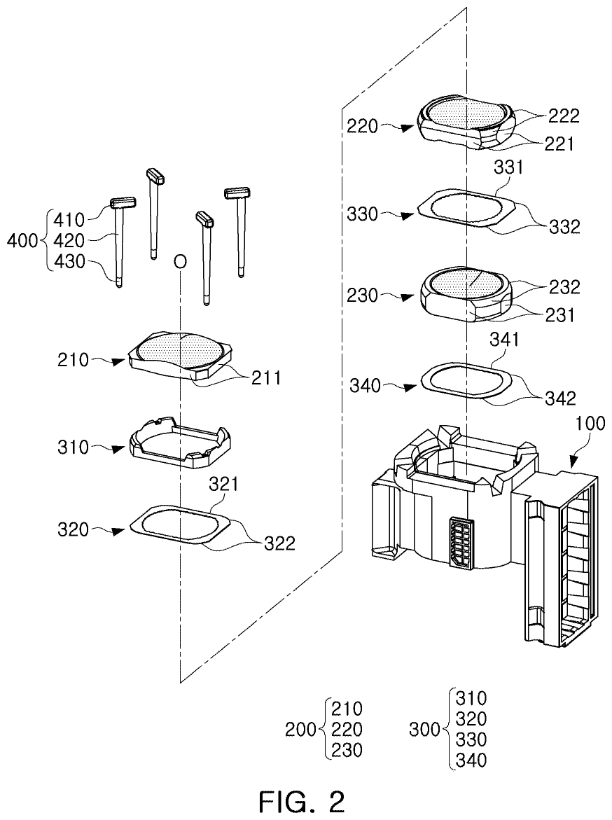

FIG. 1 illustrates a perspective view of an example lens module, in accordance with one or more embodiments. FIG. 2 illustrates an exploded perspective view of an example lens module, in accordance with one or more embodiments.

Referring to FIGS. 1 and 2, an example lens module 10, in accordance with one or more embodiments, may include a lens barrel 100, a plurality of lenses 200 disposed in the lens barrel 100 along an optical axis O, a plurality of spacers 300, and a fixing member 400 that fixes the plurality of lenses 200.

In an example, the lens barrel 100 may have a hollow cylindrical shape such that the plurality of lenses 200 that image a subject may be accommodated therein. The optical axis O that forms a focus of light incident from the outside may be formed at the central portion of the plurality of lenses 200.

The plurality of lenses 200 may be disposed in the lens barrel 100 along the optical axis O. The plurality of lenses 200 may be sequentially stacked inside the lens barrel 100.

Referring to FIG. 2, in this embodiment, the first to third lenses 210, 220, and 230 are illustrated in the order in which they are stacked along the optical axis O. However, the examples are not limited to three lenses. In an example, according to the resolution to be implemented, the lenses may be configured as three or less lenses or may include more than three lenses. The plurality of lenses 200 may be stacked as many as necessary based on the implementation of the lens module 10, and may respectively have the same or different optical properties such as refractive index or the like. In the one or more examples, for convenience, the position in which the first lens is disposed is described as the positive direction of the optical axis, and the position in which the third lens is disposed is referred to as the negative direction of the optical axis.

Each of the plurality of lenses 200 may include an optical portion through which light passes and is refracted, and a flange portion.

The optical portion of the lenses 200 may refract light reflected from a subject. Accordingly, the optical portion may have a concave, convex or meniscus shape.

The flange portion may be formed at the edge of the optical portion, and the flange portion may be a portion in contact with the lens barrel 100 or the spacer 300. Additionally, a light blocking material may be coated to the flange portion, or a light blocking film may be attached to the flange portion to prevent unnecessary light from passing through the flange portion.

A portion of the plurality of lenses 200 may include straight portions 211, 221, and 231 on side surfaces thereof. In a non-limited example, the straight portions 211, 221, and 231 may be formed on side surfaces of the plurality of lenses 200 in a direction perpendicular to the optical axis O.

The respective straight portions 211, 221, and 231 may include a pair of straight portions 211, 221, and 231 facing each other. However, the one or more examples are not limited thereto. In an example, the straight portions 211, 221, and 231 may include two pairs or more of the straight portions 211, 221, and 231.

In an example, a portion of the plurality of lenses 200 may further include circular arc portions 222 and 232 that is disposed between adjacent straight portions 211, 221, and 231. The respective circular arc portions 222 and 232 may be circular circumferential portions surrounding the optical axis O as the center from the side. However, the one or more examples are not limited thereto, and other straight portions may be disposed between the adjacent straight portions 211, 221, and 231.

The plurality of lenses 200 may be formed of glass, glass molding, thermosetting resin, thermoplastic resin, or a plastic material, but are not limited thereto.

The spacer 300 may be disposed between the plurality of lenses 200 to maintain a distance between the lenses.

In an example, one or more spacers 300 may be provided according to the number of the plurality of lenses 200. The spacer 300 may be disposed between two lenses disposed adjacently among the plurality of lenses 200 such that the plurality of lenses 200 are spaced apart from each other by a predetermined interval or distance. The thickness of the spacer 300 may be determined according to the distance between the plurality of lenses 200, and hereinafter, the spacer 300 having a relatively thin thickness will be described as a standard.

In an example, a light-blocking material may be coated to the spacer 300, or a light-blocking film may be attached to the spacer 300 to prevent unnecessary light from passing through the spacer 300.

The spacer 300 may be formed of an opaque material, and may be formed of non-ferrous metal such as copper or aluminum.

The side surfaces of the spacers may include straight portions 321, 331, and 341 and circular arc portions 322, 332, and 342. The straight portions 321, 331, and 341 may be formed in a direction perpendicular to the optical axis O from the sides. The circular arc portions 322, 332, and 342 may be circular circumferential portions surrounding the optical axis O as a center from the side.

The straight portions 321, 331, and 341 may include a pair of straight portions 321, 331, and 341 facing each other, and the circular arc portions 322, 332, and 342 may include a pair of arc portions 322, 332, and 342 facing each other. However, the one or more examples are not limited thereto, and the straight portions 321, 331 and 341 may include two pairs of facing straight portions 321, 331, 341, and the circular arc portions 322, 332, and 342 may be disposed between adjacent straight portions 321, 331, and 341.

The straight portions 321, 331, and 341 of the spacers may be disposed to face the straight portions 211, 221, and 231 of the D-cut lenses, respectively.

The fixing member 400 may be accommodated in the lens barrel 100, and may be provided in plurality. A first end of the fixing member 400 may contact the lens barrel 100, and a second end of the fixing member 400 may contact one of the plurality of lenses 200.

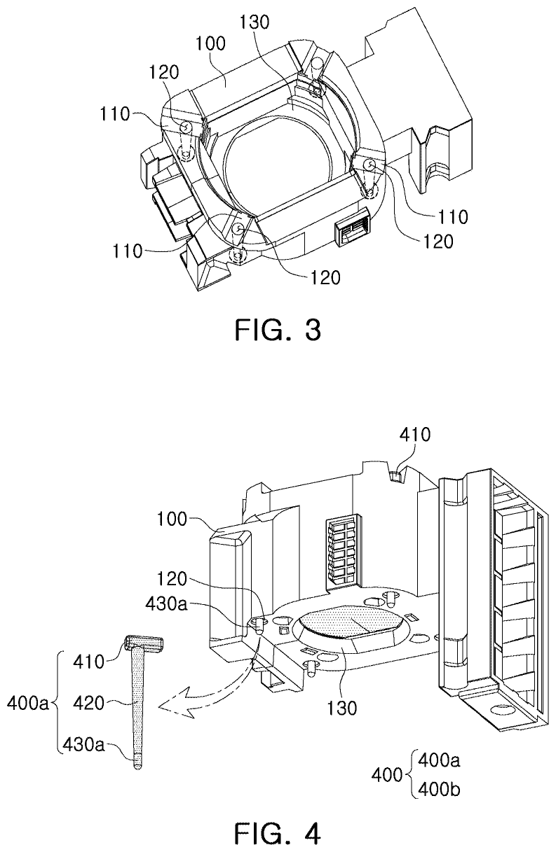

According to an embodiment, the fixing member 400 may include a fixing portion 410 and an accommodating portion 420 connected to the fixing portion 410. The accommodating portion 420 may have a certain length in the direction of the optical axis O. The fixing portion 410 may be formed in a direction perpendicular to the accommodating portion 420, but is not limited thereto. The accommodating portion 420 may be received and fixed in the lens barrel 100, and the fixing portion 410 may contact at least one of the plurality of lenses 200 outside the lens barrel 100. The fixing member 400 will be described later in detail with reference to FIGS. 3 to 6.

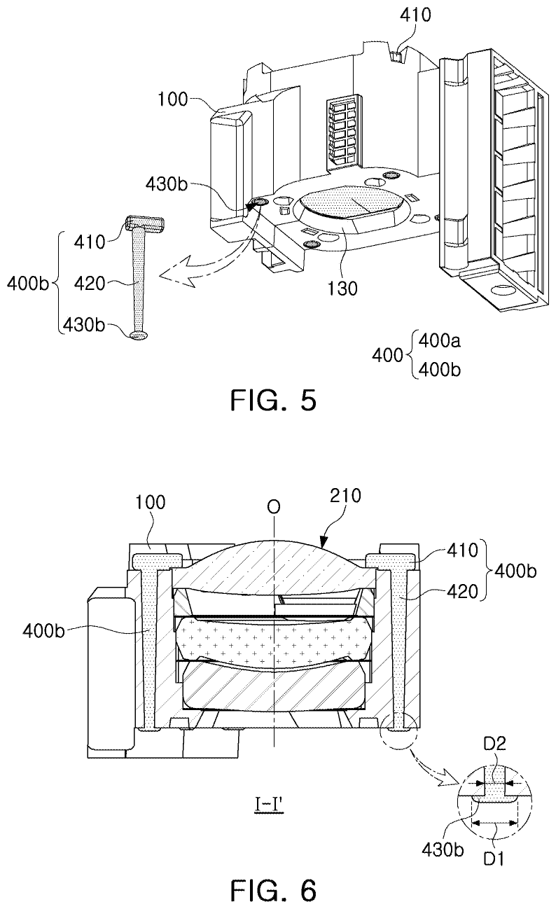

FIG. 3 is a perspective view of an example lens barrel. FIG. 4 is a perspective view of a fixing member and an example lens barrel before ultrasonic welding is performed. FIG. 5 is a perspective view of the fixing member and the lens barrel after ultrasonic welding is performed. FIG. 6 is a cross-sectional view taken along line I-I′ of FIG. 1.

Referring to FIGS. 3 and 4, the lens barrel 100 may include a groove portion 110, a through-hole 120 and a support portion 130. As the through-hole 120 and the support portion 130, a plurality of through-holes 120 and a plurality of groove portions 110 may be provided. The fixing member 400 may be disposed in the through-hole 120 and the groove portion 110.

A portion of the fixing member 400 may be accommodated in the through-hole 120. In an example, the accommodating portion 420 of the fixing member 400 may be accommodated in the through-hole 120. A portion of the fixing member 400 may be disposed in the groove portion 110. For example, the fixing portion 410 of the fixing member 400 may be disposed in the groove portion 110.

The support portion 130 may support the arrangement of the plurality of lenses 200 in the direction of the optical axis O. In an example, the plurality of lenses 200 may be sequentially stacked on the support portion 130, and the support portion 130 may support a lens disposed on an outermost side in the negative direction of the optical axis O among the plurality of lenses 200.

The lens barrel 100 may include an accommodating space in which the plurality of lenses 200 and the spacer 300 are accommodated. A plurality of lenses 200 may be disposed in an accommodation space inside the lens barrel 100, and the plurality of lenses 200 may be disposed in contact with each other or spaced apart from each other with the spacer 300 interposed therebetween.

Referring to FIGS. 4 and 5, fixing members 400a and 400b and the lens barrel 100 before and after ultrasonic welding are illustrated. FIG. 6 is a cross-sectional view taken along line I-I′ of FIG. 1, and illustrates a cross-section of a state in which the fixing member 400b is fixed to the lens barrel 100 after ultrasonic welding is performed.

Referring to FIG. 4, before ultrasonic welding is performed, the fixing member 400a may be inserted into the through-hole 120 of the lens barrel 100. The accommodating portion 420 may be formed to have a length in the direction of the optical axis O, and the fixing portion 410 may be formed to have a length in a direction perpendicular to the optical axis O. In an example, before ultrasonic welding proceeds, the fixing member 400 may have a shape tapered toward one end.

According to an embodiment, a plurality of lenses 200 and spacers 300 may be stacked in the accommodation space of the lens barrel 100, and the fixing member 400a may be inserted into the through-hole 120. When the fixing member 400a is inserted into the through-hole 120, one end 430 of the fixing member 400a may protrude outwardly of the through-hole 120.

Although not clearly illustrated in FIG. 4, the fixing portion 410 may be disposed in the groove portion 110 to press the plurality of lenses 200 in the direction of the optical axis O. In an example, the fixing portion 410 contacts the outermost lens in the positive direction of the optical axis O among the plurality of lenses 200, and the support portion 130 may support a lens disposed at the outermost side in the negative direction of the optical axis O among the plurality of lenses 200. Accordingly, the plurality of lenses 200 may be disposed in the direction of the optical axis O between the fixing portion 410 and the support portion 130 of the lens barrel.

Referring to FIGS. 5 and 6, the fixing member 400b may be ultrasonically welded, which may proceed on one end 430 of the fixing member 400b. Ultrasonic welding may be performed in a manner in which electrical energy is converted into mechanical energy through a vibration difference and then transmitted to the material to be welded. At this time, instantaneous frictional heat may be generated on the bonding surface and may form thermal fusion. A thermoplastic resin, for example, a plastic resin, may be used as the weld material to be suitable for a thermal fusion method. After ultrasonic welding is performed, the weld material may be maintained in a deformed state. In an embodiment, the fixing member 400 may be a plastic material and may be ultrasonically welded.

When the fixing member 400b is ultrasonically welded, the shape of one end 430b of the fixing member 430b may be changed. For example, one end 430b of the fixing member 400b that protrudes outwardly of the through-hole 120 may be deformed through ultrasonic welding. A first end 430b of the fixing member may be formed in a blunt form. In an example, a first end 430b of the fixing member may be plate-shaped. In an example, the diameter of one end 430 of the fixing member may be changed before and after ultrasonic welding. After ultrasonic welding, the diameter of one end of the fixing member 430b may be greater than the diameter of the accommodating portion 420. At this time, the diameter of the accommodating portion 420 may refer to the diameter of the accommodating portion 420 located adjacent to one end 430 of the fixing member.

Referring to FIG. 6, a cross-sectional view of a state in which the fixing member 400b is fixed to the lens barrel 100 after ultrasonic welding is illustrated.

Referring to FIG. 6, the fixing member 400b may be fixed to the lens barrel 100 by adjusting the length of the accommodating portion 420. For example, the length of the accommodating portion 420 in the direction of the optical axis O may be set to correspond to the length of the through-hole 120 in the direction of the optical axis O, and ultrasonic welding may be performed on one side of the fixing member 400b. At this time, a cross section of a first side of the fixing member 400b and a cross section of a second side of the fixing member 400b may be formed larger than a cross section of the through-hole 120 such that the fixing member 400b may be fixed.

Specifically, one side of the fixing member 400b may contact the lens barrel 100 and may be disposed outside the through-hole 120. One side of the fixing member 400b may be formed in a plate shape. For example, one-side end of the fixing member 400b, for example, one end 430b of the fixing member 400b may be in a plate shape to cover the through-hole 120, and may contact the lens barrel 100.

When the one end of the fixing member 430b has a plate shape, a diameter D1 of one end of the fixing member may be greater than a diameter D2 of the through-hole. In this example, the diameter D2 of the through-hole may refer to the diameter D2 of the through-hole in a position facing the one end 430b of the fixing member. As the diameter D1 of one end of the fixing member 400b may be greater than the diameter D2 of the through-hole facing the same, the one-side moving direction of the fixing member 400b may be limited.

The fixing portion 410 may be disposed on the second side of the fixing member 400b, and the fixing portion 410 may be disposed to contact one of the lens barrel 100 and the plurality of lenses 200. The fixing portion 410 may be formed to have a length in a direction perpendicular to the accommodating portion 420, and on the other side, the moving direction of the fixing member 400b may be limited.

In an example, the fixing member 400b may be in a state in which a first side of the fixing member 400b is in contact with the lens barrel 100 and a second side of the fixing member 400b is in contact with one of the plurality of lenses 200, and the moving direction of the fixing member 400b may be limited to both sides. Accordingly, the fixing member 400b may be fixed to the lens barrel 100.

The fixing portion 410 may be disposed in a fixed state to the lens barrel 100, and may press the first lens 210, at one side, such that the first lens 210 does not move in the direction of the optical axis O. Additionally, as described above in FIGS. 3 to 5, since the support portion 130 on the other side may also support the outermost lens, the plurality of lenses 200 may be maintained in a fixed state due to the support portion 130 and the fixing portion 410.

Typically, a plurality of lenses are fixed to a lens barrel by applying and curing an adhesive. Therefore, in the example in which the adhesive is deformed due to external impact or the like, a plurality of lenses may be displaced from a fixed position and a resolution problem occurs.

However, in an example, the fixing member 400b may be formed of a plastic material, and even in the event of an external impact, the plurality of lenses 200 may remain fixed to the lens barrel 100 because relatively no deformation may occur compared to adhesives.

In an example, the fixing member 400 may be provided as a plurality of fixing members. In an example, the plurality of fixing members 400 may be disposed symmetrically with respect to an optical axis O on which light is incident. Since the fixing portion 410 disposed on a first side of the lens 210 may press a first side of the first lens 210, and the fixing portion 410 disposed on a second side of the lens 210 may press the second side of the first lens 210, the first lens 210 may be uniformly pressed.

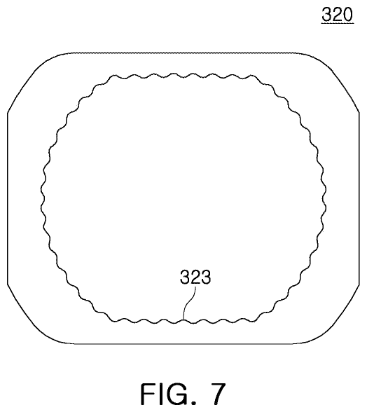

FIG. 7 illustrates a plan view of an example spacer, in accordance with one or more embodiments.

The spacer 300 may adjust the amount of light passing through the plurality of lenses 200. In an example, an incidence hole passing through the spacer 300 in the direction of the optical axis O may be formed in the spacer 300. Light incident through the plurality of lenses 200 may pass through the incidence hole.

The size of the incidence hole may be determined according to the degree to which light passing through the plurality of lenses 200 is refracted, and may be formed to an extent to which light refracted while passing through the plurality of lenses 200 may be incident to an image sensor (not illustrated).

The incidence hole may be formed in an inner side surface 323 of the spacer 300, to pass through the spacer 300, and there is a concern that light passing through the incidence hole may be reflected from the inner side surface 323 of the spacer. If light is reflected from the inner side surface 323 of the spacer and is incident on an image sensor (not illustrated), image quality may deteriorate.

However, in an example, the inner side surface 323 of the spacer may include a plurality of concave portions and a plurality of convex portions, and a flare phenomenon caused by light reflected from the inner side surface 323 of the spacer may be prevented or significantly reduced. Referring to FIG. 7, although the inner side surface 323 of the spacer includes a plurality of concave portions and a plurality of convex portions, the one or more examples are not limited to the illustrated shape. In an example, the inner side surface 323 of the spacer may be freely changed in the form of a curve, such as including a waveform portion or the like.

As set forth above, in a lens module according to one or more examples, a plurality of lenses may be fixed to a lens barrel.

Additionally, a lens module according to the one or more examples may accommodate a plurality of lenses, and a constant distance between the lenses may be maintained.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A lens module, comprising:
a lens barrel;
a plurality of lenses disposed in the lens barrel along an optical axis; and
a fixing member configured to fix at least one of the plurality of lenses to the lens barrel,
wherein the lens barrel comprises a through-hole which accommodates a portion of the fixing member,
wherein a first end of the fixing member protrudes outwardly of the through-hole, and
wherein a diameter of the first end of the fixing member is greater than a diameter of the through-hole.

2. The lens module of claim 1, wherein the fixing member comprises:
a fixing portion which contacts at least one of the plurality of lenses, and
an accommodating portion which is accommodated in the through-hole of the lens barrel.

3. The lens module of claim 2, wherein the diameter of the first end of the fixing member is greater than a diameter of the accommodating portion.

4. The lens module of claim 2, wherein the fixing portion is connected to the accommodating portion, and
wherein the fixing portion is in contact with a lens which is disposed on an outermost side of the lens barrel in a positive direction of the optical axis from among the plurality of lenses.

5. The lens module of claim 2, wherein the lens barrel comprises a support portion which supports a lens disposed on an outermost side of the lens barrel in a negative direction of the optical axis from among the plurality of lenses.

6. The lens module of claim 2, wherein the lens barrel comprises a groove portion in which the fixing portion is disposed.

7. The lens module of claim 2, wherein the accommodating portion has a length in an optical axis direction, and
the fixing portion has a length in a direction, perpendicular to the optical axis direction.

8. The lens module of claim 1, wherein the fixing member is formed of a plastic material.

9. The lens module of claim 1, further comprising a spacer disposed between two lenses disposed adjacently among the plurality of lenses.

10. The lens module of claim 1, wherein the fixing member is provided in a plural number.

11. The lens module of claim 10, wherein the fixing member is disposed symmetrically with respect to the optical axis.

12. A lens module, comprising:
a lens barrel;
a plurality of lenses disposed in the lens barrel along an optical axis; and
a fixing member configured to fix at least one of the plurality of lenses to the lens barrel,
wherein a first side of the fixing member contacts the lens barrel,
wherein a second side of the fixing member is in contact with one of the plurality of lenses, and
wherein the fixing member is fixed to the lens barrel.

13. The lens module of claim 12, further comprising a spacer disposed between two lenses disposed adjacently among the plurality of lenses.

14. The lens module of claim 12, wherein the fixing member is formed of a plastic material.

15. The lens module of claim 12, wherein the first side of the fixing member is plate-shaped.

16. The lens module of claim 12, wherein the lens barrel comprises a through-hole in which a portion of the fixing member is accommodated.

17. A lens module, comprising:
a lens barrel comprising a through-hole;
a plurality of lenses disposed in the lens barrel on an optical axis; and
a fixing pin configured to fix a first lens of the plurality of lenses to the lens barrel,
wherein the fixing pin is disposed in the through-hole,
wherein a first end of the fixing pin contacts the lens barrel and the first lens, and
wherein a second end of the fixing pin is welded to the lens barrel to cover the through-hole.

18. The lens module of claim 17, wherein a diameter of the first end of the fixing member is greater than a diameter of the through-hole.

19. The lens module of claim 17, wherein a diameter of the second end of the fixing pin is greater than a diameter of a lower end of the through-hole.
